(19) United States
(12) Patent Application Publication
(10) Pub. No.: US 2002/0075558 A1
(43) Pub. Date: Jun. 20, 2002

(54) Wavelength converter apparatus for ultra-high speed optical signal process

(76) Inventors: Dong Hwan Kim, Seoul (KR); Kyung Sun Choi, Seoul (KR); Jae Cheol Jo, Seoul (KR); Sang Bae Lee, Seoul (KR); Jung Young Son, Seong Nam (KR)

Correspondence Address: BACON & THOMAS, PLLC, 625 Slaters Lane - 4th Floor, Alexandra, VA, 22314-1176, US

(21) Appl. No.: 09/756,756

(22) Filed: Jan. 10, 2001

(30) Foreign Application Priority Data
Oct. 17, 2000 (KR) 10-2000-61076

(51) Int. Cl. G02F 1/365

(52) U.S. Cl. 359/332; 359/326

(57) ABSTRACT

The present invention relates to a wavelength converter apparatus for ultra-high speed optical signal process. So, the present invention (a)embodies a wavelength converter which does not need an outer pump light by composing a semiconductor optical amplifier-ring type laser and (b)provides a wavelength converter apparatus for ultra-high speed optical signal process which embodies to be always operated wavelength conversion to be always possible within the amplifying bandwidth(about 40 mm) of SOA by a wavelength-tunable optical band pass filter deposited in a laser resonator.

Therefore, the present invention (a)does not need the external pump light because converted wavelength is tuned within the amplifying bandwidth of SOA, and the own laser oscillation wavelength is used as a pump light, (b)can be used as an original WDM optical wavelength converter because the present invention can be used in the range 1.55 um, and (c) can be used not only as an ultra-high speed optical communication element of next generation(such as ultra-high speed all-optical wavelength converter over 10 Gbps) but also as an optical switch element (such as an optical signal connector) because the reaction speed of SOA which is used as a wavelength converter is up to sub-pico second and the wavelength conversion is possible up to the speed terra bit per a second.

### BACKGROUND OF THE INVENTION

1. Field of the Invention

The present invention relates to a wavelength converter apparatus for ultra-high speed optical signal process. More particularly, it relates to a ultra-high speed wavelength converter which is operated without an external pump light by composing a semiconductor-optical fiber ring-type laser taking a semiconductor optical amplifier(SOA) as a laser gain medium being different from a semiconductor optical amplifier-four wave mixing (SOA-FWM) method in the conventional single pass method.

2. Description of the Related Art

Recently, the study of the optical transmission networks by WDM (Wavelength Division Multiplexing) method is undergoing due to the necessity of the transmission of huge capacity with ultra-high speed.

The wavelength conversion technique connects each of the different wavelength channels in the WDM optical communication networks or is used as a conversion element. Also, it is focused on studying as an optical switching technique. Specially, a SOA in the wavelength conversion technique by using a SOA can be integrated with a semiconductor optical source or an optical element. Also, a SOA is smaller than an optical fiber. Therefore, many study results about SOA as a medium of a wavelength converter are reported.

The wavelength conversion in the non-linear optical medium is accomplished by wave mixing of input wavelength by leading of Nonlinear Electric Polarization. And the represented wavelength conversion used in an optical communication field is performed as occurring the new wavelength by FWM which happens in a non-linear medium of a SOA and an optical fiber. The FWM in an optical fiber is a Parametric conversion which happens only when input waves strength is large, while the FWM signal is easily observed in the SOA only with inserting small strength input because the non-linear wave mixing and the optical amplifying are performed at the same time.

The conventional wavelength conversion technique using the conventional SOA embodied a wavelength converter by using FWM of a single pass method, but another wavelength pump wave(λ₂) in addition to an input wavelength is needed for performing the wavelength conversion of an input optical signal wave(λ₁) of the SOA. Therefore, the new wavelengths in the SOA occur by mixing two input waves. In other words, the new two optical waves (2λ₂-λ₁ and 2λ₁-λ₂) occur, which are mixture of the FWM signal waves.

Here, since the down-conversion efficiency of the FWM is higher than the up-conversion efficiency of the FWM in the SOA, after setting the input wavelength as a longer wavelength than pump wave, the FWM signal(2λ₂-λ₁, λ₁>λ₂) with short wave is used as a processing signal.

The FWM signal strength is proportioned to a square of the pump wave strength and is proportioned linearly to the input wave strength. So, because the FWM signal keeps the phase information of the input wave, the SOA-FWM phenomenon is used also as a phase detector in a phase locked loop(PLL). In other words, the system becomes complicated because the external pump wave should be tunable to make the converted wavelength to be tunable and therefore, the cost goes up.

### SUMMARY OF THE INVENTION

Therefore, the present invention is invented to solve the disadvantage of the necessary external pump wave. The purpose of the present invention is to provide a wavelength converter apparatus for ultra-high speed optical signal process which embodies (a)a wavelength converter which is used for optical connecting or ultra-high speed optical signal processing, and (b) a SOA-optical fiber laser type wavelength converter of which reacting conversion speed is as rapidly as sub-pico second and of which wavelength conversion is possible in a small input wave strength.

So, the present invention for obtaining the mentioned purposes in the technical theory (a)embodies a wavelength converter which does not need an external pump light by composing a semiconductor-optical fiber ring-type laser and (b)provides a wavelength converter apparatus for ultra-high speed optical signal process which embodies the wavelength conversion to be always possible within the amplifying bandwidth(about 40 mm) of a SOA by a wavelength-tunable optical band pass filter equipped in a laser resonator.

### BRIEF DESCRIPTION OF THE DRAWINGS

FIG. 1 is a schematic diagram showing a wavelength converter apparatus for ultra-high speed optical signal process.

FIG. 2a and 2b are graphs comparing an input pulse train according to the experiment result of the present invention to a pulse train of the wavelength converted signal light.

FIG. 3 is a graph comparing the optical spectrums of an optical signal(1548 nm), a laser optical signal(1544 nm), and a wavelength converted optical signal(1540nm) according to the experiment result of the present invention.

FIG. 4 is a graph showing the change of the FWM signal output strength accordance with input pulse light strength of a wavelength converter according to the experiment result of the present invention.

### *Description for numerals in the drawing*

100: Mode Locking Laser

120: Optical Attenuator

140: PC(Polarization Controller)

160: 3-dB Optical Fiber Coupler

180: Optical Isolator

200: SOA(Semiconductor Optical Amplifier)

220: Output-Tunable Optical Fiber Coupler

240: Wavelength-Tunable Optical Band Pass Filter

260: PC(Polarization Controller)

280: Optical Spectrum Analyzer

300: EDFA(Erbium Doped Fiber Amplifier)

320: Optical band pass filter

340: Oscilloscope

### DETAILED DESCRIPTION OF THE EMBODIMENTS

The composition and operation of the present invention according to the preferred embodiment of the present invention will be explained with reference to the accompanying drawings.

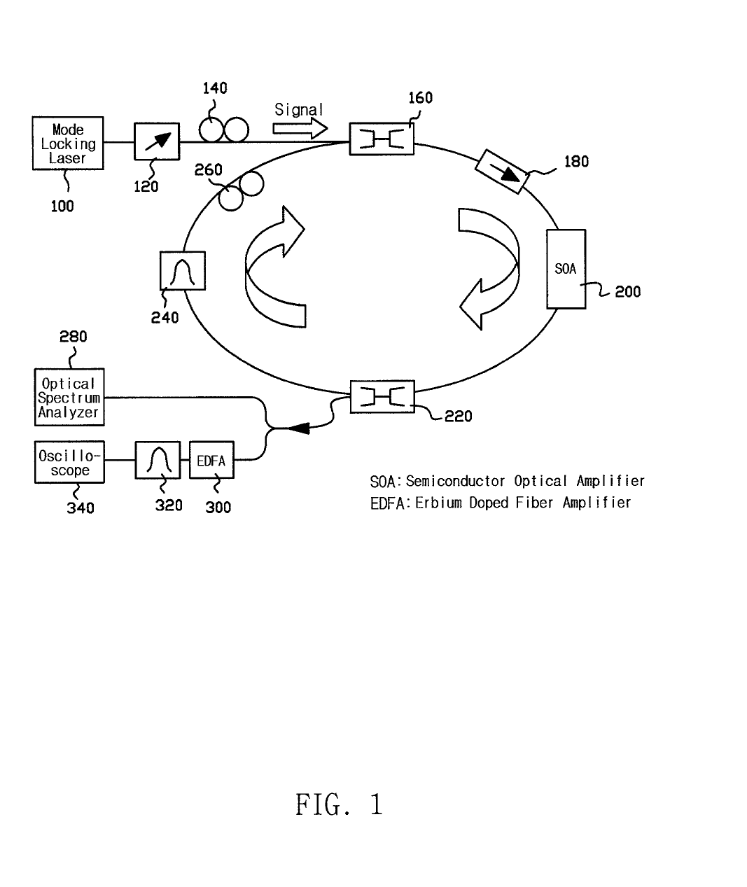

FIG. 1 is a schematic diagram showing a wavelength converter apparatus for ultra-high speed optical signal process.

The wavelength converter apparatus for ultra-high speed optical signal process has a mode locking laser(100), an optical attenuator(120) which attenuates optical output of the optical fiber, the 1^{st} and 2^{nd} polarization controllers(140, 260) which fit polarization state for gaining the maximum FWM efficiency because the FWM efficiency using a SOA has dependence on the polarization, a 3-dB optical coupler(160) which splits the optical strength in 50 to 50, an optical isolator(180) which transmits the optical wavelength of an optical fiber, a SOA(200) which is operated as a laser gain medium or a wavelength converter, an output-tunable coupler(220) which tunes the output strength of an optical fiber and then couples the strength, a wavelength-tunable optical band pass filter(240) which couples an optical wavelength of an optical fiber and then filters the wavelength, an optical spectrum analyzer(280), an EDFA(300) which amplifies an optical wavelength of an erbium doped optical fiber, an optical band pass filter(320), and an Oscilloscope(340).

Here, a SOA(200) has a 40 nm amplifying bandwidth around the 1.5 um center wavelength and is deposited with a reflectionless thin film for adjusting the length as 1 mm, the liftime as 2 ns, and the reflection percentage of both side of the film as 10⁻³˜10⁻⁴. Also, the SOA has about 23 dB fiber-to-fiber gain and the saturated output strength of 7.5 dBm under the maximum pumping electricity of 200 mA.

The embodiment operation of FIG. 1 is as followings. If electricity power(160˜180 mA) is added to a SOA(200), the light of the continuous type laser wavelength occurs through an output-tunable optical fiber coupler(220) by a SOA(22) and a wavelength-tunable optical band pass filter(240) in the resonator even without an optical signal in the center wavelength of an optical fiber.

Here, when an input optical pulse train(λ ₁) of 10 Gbit/s speed is inserted through the 3dB-optical fiber coupler(160) near 1.55 mu, the wavelength of 2λ ₂₋ λ ₁ is output through an output-tunable optical fiber coupler(220) by leading a laser wavelength(λ ₂2) and a FWM which are occurred in a SOA(200).

In the mean time, because there is a wavelength-tunable optical band pass filter(240) at the next step of the optical fiber coupler(220), the new occurred FWM signal(2λ ₂₋ λ₁) can not feedback a resonator so that it does not effect the laser wave strength, which acts as a pump wave. Also, a polarization coupler(260) in a resonator couples the polarization states of laser wavelength and input wave and maximizes the efficiency of the FWM.

The output-tunable optical fiber coupler(220) used in the present invention can control the outputting FWM signal strength by controlling the percentage of the coupling, the loss of a SOA-optical fiber laser, and the gain percentage of a SOA(200).

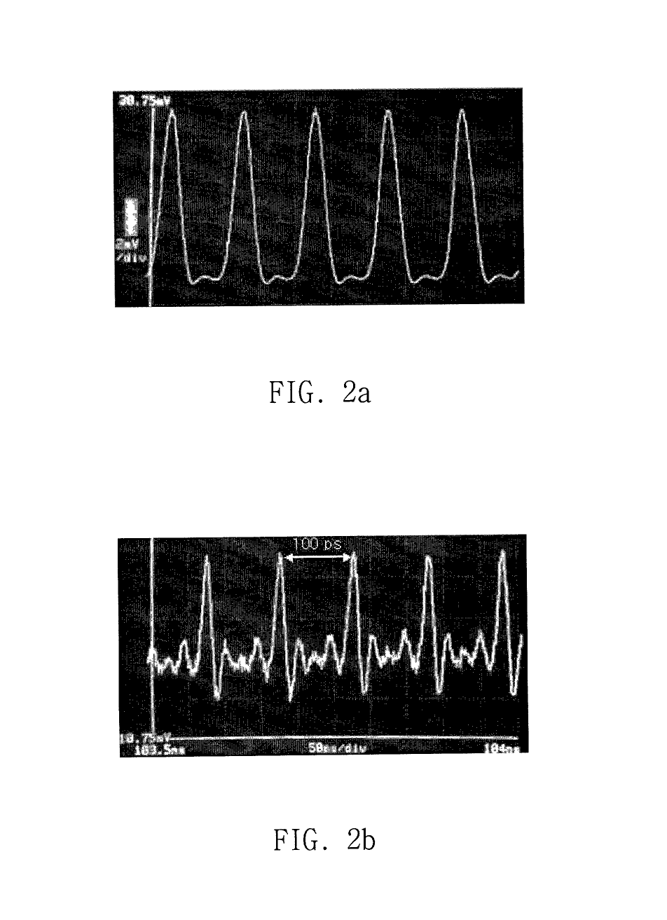

FIG. 2a and 2b are optical spectrum graphs comparing an input pulse train according to the experiment result of the present invention with a pulse train of the wavelength converted signal light. FIG. 2b shows an output optical pulse train of 10 Gbit/s of the converted wavelength wherein the input optical pulse train of 10 Gbit/s in FIG. 2a is input or output by the wavelength converter of the present invention.

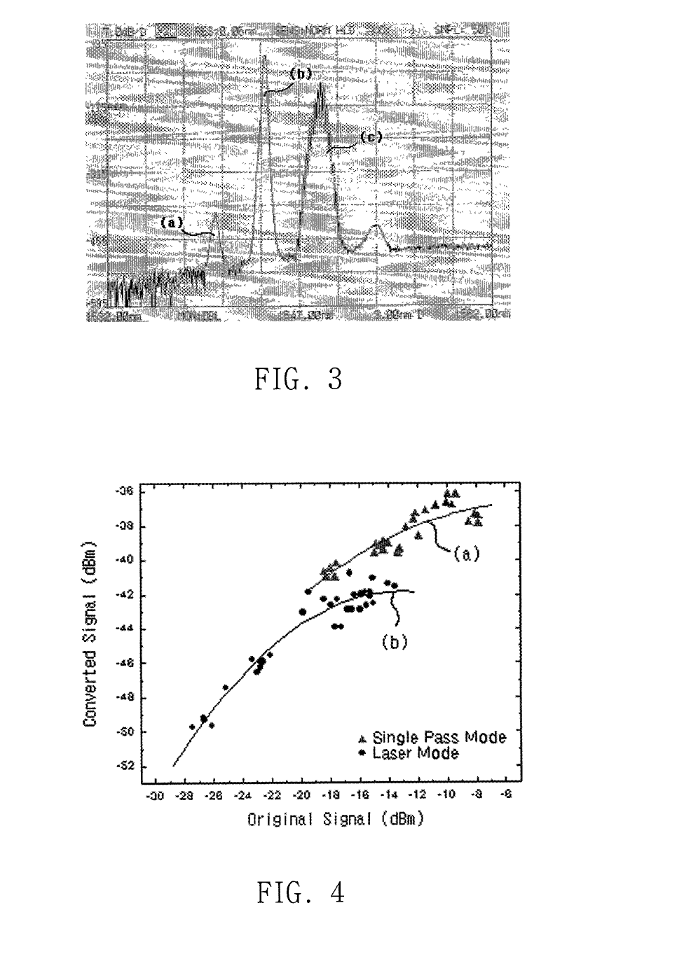

FIG. 3 shows optical wavelength spectrums whichare outputted from a wavelength converter. The spectrums are (a) FWM optical wavelength spectrum converted from FWM of 10 Gbps, (b)optical wavelength spectrum of a semiconductor-optical fiber ring-type laser, and (c)input optical wavelength spectrum of 10Gpbs. Specially, because the input optical wavelength spectrum(c) uses a mode locked optical fiber spectrum, the tuning wavelength bandwidth is showed relatively widely.

FIG. 4 shows the relation between the input optical pulse train strength and the FWM signal wave strength of (b), which shows that the wavelength conversion signal is not increased any more due to the gain saturation if the input optical pulse train strength is over −20 dBm. In the mean time, FIG. 4 shows the relation between input optical pulse train and single pass type FWM signal strength of (a) which shows that output can not be observed if an input optical pulse train is under −20 dBm.

According to the wavelength converter apparatus for ultra-high speed optical signal process of the present invention, the ultra-high speed wavelength converter can be embodied, which doesn't need external pump light by composing the SFRL having a semiconductor optical amplifier laser as a gain medium. In other words, the wavelength converter apparatus for ultra-high speed optical signal process can be embodied, of which wavelength is tunable in the range 1.55 um and which doesn't need external pump light.

Therefore, the semiconductor-optical fiber type wavelength converter according to the present invention (a)does not need the external pump light because converted wavelength is tuned within the amplifying bandwidth of a SOA, and the own laser oscillation wavelength is used as a pump light, (b)can be used as an original WDM optical wavelength converter because the present invention can be used in the range 1.55 um, and (c)can be used not only as an ultra-high speed optical communication element of next generation(such as ultra-high speed all-optical wavelength converter over 10 Gbps) but also as an optical switch element (such as an optical signal connector) because the reaction speed of a SOA which is used as a wavelength converter is up to sub-pico second and the wavelength conversion is possible up to the speed terra bit per a second.

What is claimed is:

1. A wavelength converter apparatus for ultra-high speed optical signal process using a semiconductor-optical fiber laser, which is comprised of;
(a)1^{st} and 2^{nd} polarization controller for controlling the polarization state,
(b)a 3-dB optical coupler which splits optical strength as 50 to 50,
(c)an optical isolator which transmits the optical wavelength of an optical fiber,
(d)a SOA which amplifies an optical wavelength of a semiconductor optical fiber as a laser gain medium or a wavelength converter,
(e)an output-tunable coupler which tunes an output strength of an optical fiber and then couples the strength, and
(f)a wavelength-tunable optical band pass filter which couples an optical wavelength of an optical fiber and then filters the wavelength, and
wherein the light of the continuous type laser wavelength occurs through an output-tunable optical fiber coupler by a SOA and a wavelength-tunable optical band pass filter in the resonator even without an optical signal in the center wavelength of a optical fiber if electricity power(160˜180 mA) is added to the mentioned SOA.

2. The wavelength converter apparatus for ultra-high speed optical signal process according to claim 1, wherein the wavelength of 2λ ₂₋ λ ₁ is output through an output-tunable optical fiber coupler by leading the mixing a laser wavelength and a FWM occurred in a SOA when an input optical pulse train(λ ₁) is inserted through the said 3 dB-optical fiber coupler.

3. The wavelength converter apparatus for ultra-high speed optical signal process according to claim 2, wherein an input optical pulse train(λ ₁) is inserted with 10 Gbit/s speed when the 3dB-optical fiber coupler is 1.55 um.
